(19) United States
(12) Patent Application Publication
(10) Pub. No.: US 2021/0312120 A1
(43) Pub. Date: Oct. 7, 2021

(54) AUTOMATED GENERATION OF A TEMPLATE FOR A SHOPPABLE ELECTRONIC MESSAGE

(71) Applicant: Skipify, Inc., Danville, CA (US)

(72) Inventors: Erythean MARTIN, Danville, CA (US); Rashad ITANI, San Jose, CA (US); Jeremiah ANDERSON, Los Altos, CA (US); Zach THIGPEN, San Francisco, CA (US)

(73) Assignee: Skipify, Inc., Danville, CA (US)

(21) Appl. No.: 17/222,948

(22) Filed: Apr. 5, 2021

Related U.S. Application Data
(60) Provisional application No. 63/005,414, filed on Apr. 5, 2020.
(60) Provisional application No. 63/005,415, filed on Apr. 5, 2020.
(60) Provisional application No. 63/005,418, filed on Apr. 5, 2020.
(60) Provisional application No. 63/005,419, filed on Apr. 5, 2020.
(60) Provisional application No. 63/094,969, filed on Oct. 22, 2020.
(60) Provisional application No. 63/115,621, filed on Nov. 19, 2020.

(51) Int. Cl. G06F 40/154; G06Q 30/06; G06F 40/143

(52) U.S. Cl. CPC G06F 40/154; G06F 40/143; G06Q 30/0641

(57) ABSTRACT

A method for generating a template for a shoppable electronic message has been described. One example method includes receiving at a processor a static template that references item information; with the processor, identifying a first portion of code included in the static template that is associated with causing the item information to be displayed when the first portion of code is interpreted by a client application, and with the processor, generating a dynamic template by adding a second portion of code to the static template, wherein the second portion of code, when interpreted by the client application, enables an interaction functionality of the shoppable electronic message that is associated with the item information and includes an ability to receive a user input.

### CROSS-REFERENCE TO RELATED APPLICATIONS

The present application claims the benefit of U.S. Provisional Application No. 63/005,414 filed Apr. 5, 2020 and entitled “METHOD FOR CREATING OMNI-CHANNEL INSTANT PURCHASING, EXTENDING PURCHASING OFF A MERCHANT'S WEBSITE AND INTO OTHER CHANNELS, U.S. Provisional Application No. 63/005,415 filed Apr. 5, 2020 and entitled “METHOD FOR ENABLING PURCHASING ON A MERCHANT WEBSITE WHEREBY SHOPPER DOES NOT ADD ITEMS TO A CART”, U.S. Provisional Application No. 63/005,418 filed Apr. 5, 2020 and entitled “METHOD FOR INSTANT PURCHASING INSIDE A SOCIAL NETWORK”, U.S. Provisional Application No. 63/005,419 filed Apr. 5, 2020 and entitled “METHOD FOR INSTANT PURCHASING INSIDE EMAIL”, U.S. Provisional Application No. 63/094,969 filed Oct. 22, 2020 and entitled “SHOPPABLE EMAIL”, and U.S. Provisional Application No. 63/115,621 filed Nov. 19, 2020 and entitled “AUTOMATIC SHOPPABLE EMAIL”. The aforementioned U.S. Provisional applications, including any appendices or attachments thereof, are hereby incorporated by reference in their entirety.

### BACKGROUND

Unless otherwise indicated herein, the approaches described in this section are not prior art to the claims in this application and are not admitted to be prior art by inclusion in this section.

The development of e-commerce has enabled merchants and manufacturers to electronically combine advertising and presentation of products and services with receiving orders for such products directly from a customer. Thus, manufacturers and/or sellers of products and services can both describe a product to a customer and receive electronically transmitted orders from the customer for the product, for example, through an Internet web site. In this way, e-commerce facilitates the selection and ordering process, greatly increasing sales. As a result, e-commerce has greatly expanded in recent years and continues to expand. Because the e-commerce market is so large, even small sources of friction in the process can result in significant losses of potential sales. Consequently, any systems or techniques that can reduce friction in the on-line shopping process for an e-commerce consumer are highly beneficial and can avoid many otherwise lost sales.

Email marketing, which involves using email to send advertisements or solicit sales, makes up a substantial portion of the e-commerce market. Email marketers today generally relay on email tools that are available through an email service provider (ESP) or an email editor application to generate Hypertext Markup Language (HTML) based programs and templates. Conventional HTML-based email templates do not support Accelerated Mobile Pages (AMP) or other protocols that allow recipients of an email to interact dynamically with content directly in the email message. Thus, emails generated using such email templates do not allow for shopper interactivity or direct purchase inside of the email message when opened by the shopper, which increases friction and reduces sales. For example, for a shopper to purchase a product he or she was emailed about via a conventional static email, that shopper needs to click through the email message, connect to a website to find the product, and perform a site-specific checkout protocol. This process could take two minutes or more, assuming there are no connectivity or other issues. It is estimated that over 70 percent of shoppers attempting to purchase an item through an email on a desktop and almost 90 percent of shoppers attempting to purchase the item through an email on a mobile device abandon this cumbersome process.

Many ESPs do not offer the generation of email templates that employ AMP or other dynamic protocols, and as a result merchants that rely on such providers cannot deploy interactive or AMP-based emails at all. As for the few email service providers that do offer emails compatible with AMP-based or other dynamic protocols, a merchant is often forced to spend resources and time to convert the source code of an existing static email template to an email template that supports a dynamic email protocol. This generally involves manually editing the existing static email template with an email editing application or outsourcing the conversion process to a software developer to generate custom code for a single dynamic email template. Further, because different client applications may only support certain dynamic protocols, to maximize the number of dynamic emails that are received by prospective customers across different email client applications, the merchant must spend the resources and time to perform such a conversion for each dynamic protocol that is in use by the prospective customers, such as AMP, dynamic HTML, and the like. Thus, for e-commerce merchants, the benefits of using interactive emails for email marketing is offset by the significant additional effort and time required to generate the code of the templates for such emails.

### SUMMARY

In accordance with at least some embodiments of the present disclosure, an electronic message (e.g., email) generation system enables the automated conversion of a static template of an e-commerce merchant into one or more “shoppable” templates for the electronic message. Each shoppable email template can be employed to generate shoppable emails for a plurality of recipients. Each shoppable email, when opened by a recipient via an email client application, allows the recipient to interactively perform shopping- and purchasing-related activities directly through the email. For example, in some embodiments, the shoppable email allows a particular email recipient to view and/or select real-time product options, place orders, modify orders, and/or complete a checkout process from inside the email being viewed by the recipient. Thus, in some embodiments, a fully functional shopping cart and associated operations is available from within the shoppable email being viewed by the recipient. Further, in some embodiments, for a particular static email template, the template generation system generates multiple shoppable email templates, where each different shoppable email template is configured to support a different dynamic email protocol (e.g., AMP, dynamic HTML, and the like). The herein-described template generation system generates the multiple shoppable email templates without any additional coding operations or increased complexity on the part of the e-commerce merchant.

Further embodiments include a non-transitory computer-readable storage medium comprising instructions that cause a computer system to carry out one or more of the above methods, as well as a computer system configured to carry out one or more of the above methods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 is a block diagram of a template generation system, according to one or more embodiments.

FIG. 2 schematically illustrates a graphical user interface of a computing device displaying dynamic email content of a dynamic email that has been opened by a client application, according to an embodiment.

FIG. 3 is a flowchart illustrating the steps performed by the template generation system of FIG. 1 as part of a template generation process, according to various embodiments.

FIG. 4 is a block diagram of a template generation system, according to one or more other embodiments.

FIG. 5 is a flowchart illustrating the steps performed by the template generation system of FIG. 5 as part of a template generation process, according to various embodiments.

FIG. 6 is a flowchart illustrating the steps of an online purchasing process, according to various embodiments.

FIG. 7 is an illustration of a computing device configured to perform various embodiments of the present disclosure

For clarity, identical reference numbers have been used, where applicable, to designate identical elements that are common between figures. It is contemplated that features of one embodiment may be incorporated in other embodiments without further recitation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the disclosure, as generally described herein, and illustrated in the figures, can be arranged, substituted, combined, and designed in a wide variety of different configurations, all of which are explicitly contemplated and make part of this disclosure.

### Generation of Dynamic Template with Shoppable Areas

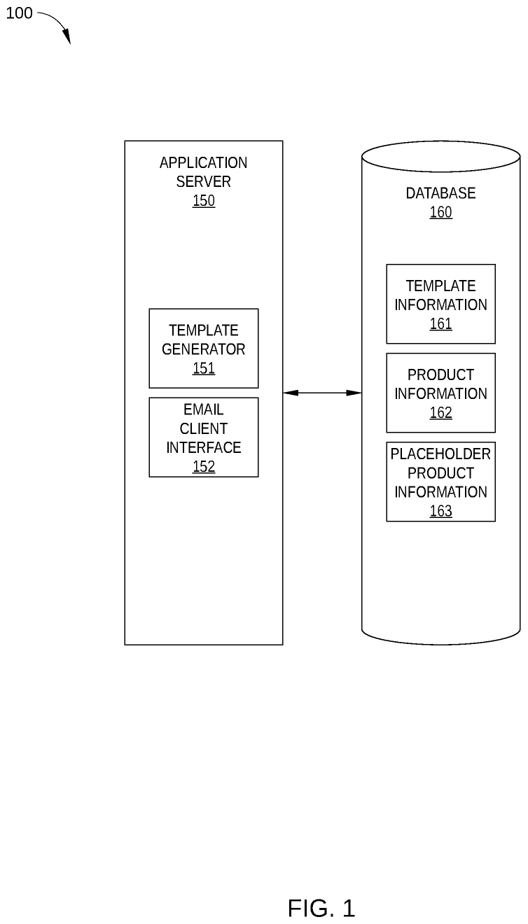

FIG. 1 is a block diagram of a template generation system 100, according to one or more embodiments. As described below, template generation system 100 generates one or more templates based a particular static email template, where each generated template can be employed to generate shoppable electronic messages for one or more recipients. Some examples of an electronic message include, without limitation, email, a text message, an instant message, a web page of a website, etc. By opening such a shoppable electronic message with a suitable client application, the recipient can interactively perform shopping- and purchasing-related activities directly through the client application without opening another application (such as a web browser that establishes a connection to a merchant web site). Thus, in some embodiments, the shoppable electronic message allows a particular recipient to view and/or select real-time product options, place orders, modify orders, and/or complete a checkout process from inside the electronic message being viewed by the recipient.

Template generation system 100 includes an application server 150 and a database 160. In some embodiments, application server 150 and/or database 160 are communicatively coupled to each other and/or to other computing devices by one or more communication networks (not shown). The other computing devices may include a merchant server, an email server, and/or an online transaction server, which are each described in greater detail below. The one or more communication networks can each include a wireless local area network (WLAN), a cellular network, a wired communication network (such as a local area network), or any combination thereof. Furthermore, one or more additional communication networks may also be employed to communicatively couple application server 150, database 160, and/or other computing devices, such as the Internet, among others.

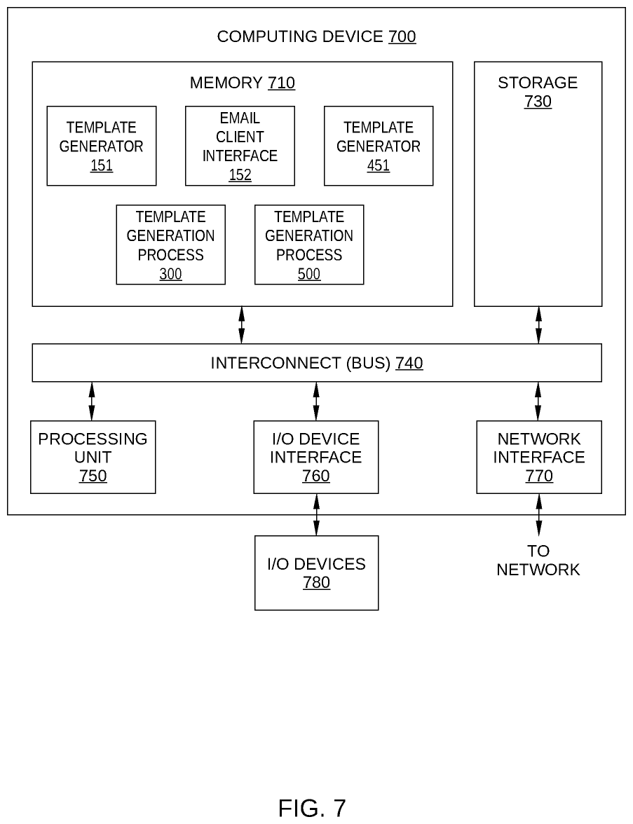

Application server 150 is configured to perform operations associated with various embodiments described herein. In some embodiments, application server 150 includes one or more of a template generator 151 and an email client interface 152. Application server 150 can be implemented as a computing device, an application running on an instance of virtual machine, and the like. In some embodiments, application server 150 is implemented as one or more instances of computing device 700, which is described below in conjunction with FIG. 7.

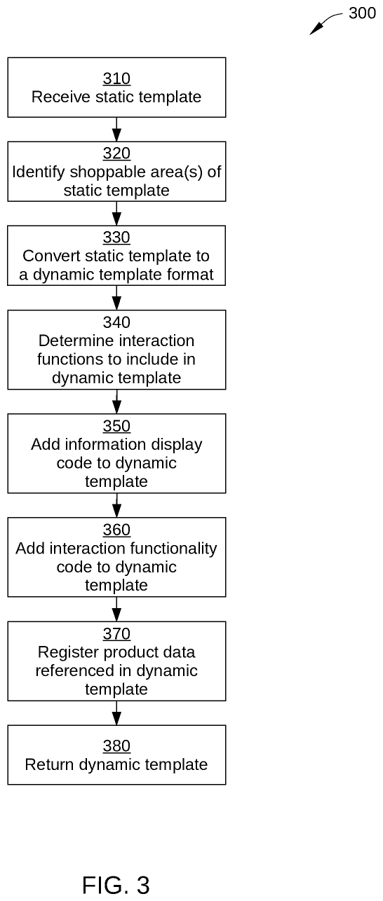

Template generator 151 is configured to perform operations associated with generating one or more shoppable email templates, based on a static email template. For example, in some embodiments, such operations include receiving a static template; identifying one or more shoppable areas of the static template; converting the static template to a dynamic template format; determining a group of one or more interaction functions to include in the dynamic template; adding information display code to the dynamic template; adding interaction functionality instructions to the dynamic template; registering product data referenced in the dynamic template; and/or returning the dynamic template for subsequent use; among others. Such operations are described below in conjunction with FIG. 3.

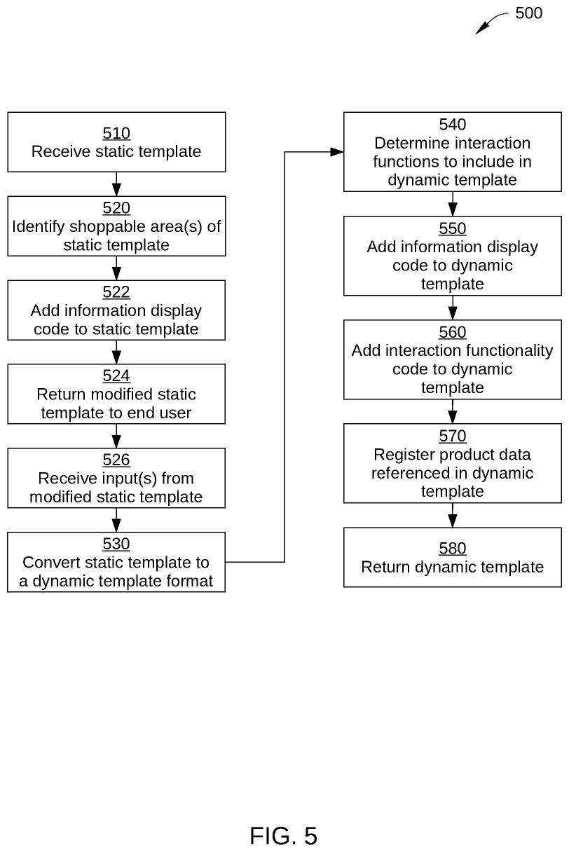

A client interface, such as email client interface 152, is configured to perform operations associated with facilitating use of a shoppable electronic message that is based on a dynamic template generated by template generator 151. For example, in some embodiments, such operations include retrieving item information that is requested by a dynamic email running on a client application, such as an email client application; sending such item information to the client application; retrieving item option information that is requested by the dynamic email; and sending such item option information to the client application; among others. Such operations are described below in conjunction with FIG. 5.

Database 160 is configured to store information facilitating the generation of dynamic email templates and the use of shoppable emails generated based on such a dynamic email template. In the embodiment illustrated in FIG. 1, database 160 is implemented in a computing device that is separate from application server 150. In other embodiments, database 160 can be incorporated in application server 150. In some embodiments, database 160 stores template data 161, product data 162, and/or placeholder product data 163.

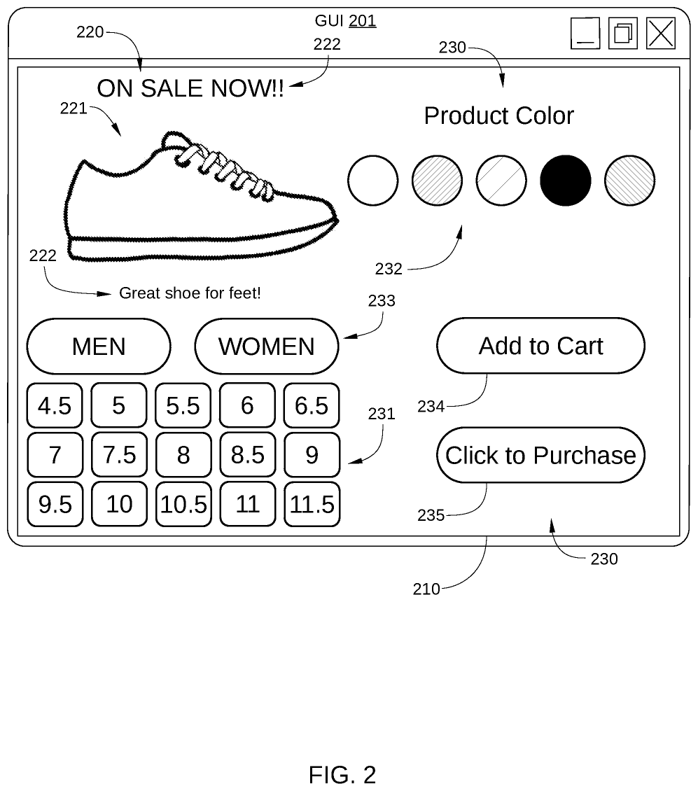

Template data 161 includes dynamic templates that are generated by template generator 151, such as dynamic email templates or other templates for other electronic messages. In some embodiments, each dynamic template is a file written in a structured markup language for encoding documents in a format that is both human-readable and machine-readable, such as such as HTML, cascading style sheets (CSS), or extensible markup language (XML). Each dynamic template included in template data 161 can be employed to generate one or a plurality of dynamic, “shoppable” emails. One embodiment of a dynamic shoppable email is described below in conjunction with FIG. 2.

FIG. 2 schematically illustrates a graphical user interface 201 of a computing device displaying dynamic email content 210 of a dynamic email (not shown) that has been opened by a client application, according to an embodiment. The dynamic email is a file that includes code from a structured markup language, and is a single instance of an email that is generated by a dynamic template that can be stored in template data 161 of FIG. 1. The dynamic email is configured to allow a recipient of the dynamic email to interactively perform shopping- and purchasing-related activities directly through the displayed dynamic email content 210. For example, in some embodiments, the dynamic email allows a particular email recipient to view and/or select real-time product options, place orders, modify orders, and/or complete a checkout process via a client application that has opened the dynamic email and caused dynamic email content 210 to be displayed.

As shown, when the dynamic email is opened by the client application, item information 220 referenced in the code (not shown) of the dynamic email is displayed by the client application. For example, in the embodiment illustrated in FIG. 2, item information 220 includes information associated with one or more items (e.g., specific products or services) available from an e-commerce merchant, such as an image 221 of a particular product, a written description 222 of the particular product, product pricing (not shown), and/or the like.

In addition, when the dynamic email is opened by the client application, certain interaction functions that are associated with one or more items are enabled by one or more user interface elements 230 that are displayed by the client application. In some embodiments, such interaction functions include one or more option selection functions and/or one or more transaction functions. For example, in the embodiment illustrated in FIG. 2, such user interface elements 230 include one or more available size buttons 231 of a particular product, a menu 232 of available colors, gender selection buttons 233, and/or the like. In some embodiments, one or more user interface elements 230 can include a plurality of buttons, be implemented as a drop-down menu, and/or the like. In some embodiments, one or more user interface elements 230 are based on option information retrieved from product data 162, which can be stored in database 160. For example, in some embodiments, when a dynamic email is opened that includes a reference to a particular item, option information that is associated with the referenced item can be retrieved from product data 162, such as up-to-date color and/or size availability. In such embodiments, the specific user interface elements 230 are displayed as part of dynamic email content 210 area based on the retrieved option information.

Additionally or alternatively, in some embodiments, user interface elements 230 include one or more transaction buttons (or other input areas), such as an add-to-cart button 234 and/or a click-to-purchase button 235. Generally, such user interface elements 230 (e.g., add-to-cart button 234 and/or click-to-purchase button 235) enable an ability to receive a user input, such as a mouse click, a finger tap, a mouse hover, and/or the like. In some embodiments, add-to-cart button 234 enable a particular selected item to be added to a shopping cart that is associated with the dynamic email, and therefore is retained in the client application. That is, the specific item(s) in dynamic email selected by a user to be included in the shopping cart (via add-to-cart-button 234) are tracked via the code included in the dynamic email. Thus, unlike a conventional online shopping cart, the shopping cart that is associated with the dynamic email is not maintained and updated at a merchant website. In some embodiments, click-to-purchase button 235 enables a recipient of the dynamic email to complete an online transaction for purchasing selected item(s) via a single input action. Thus, after performing the single input action, the online transaction for purchasing the selected item(s) is implemented with no further actions of the part of the user, such as inputting shipping and billing information. It is noted that code enabling such functionality for click-to-purchase button 235 is included in the code of the dynamic email, and is not implemented via a merchant website or third-party purchasing entity.

Returning to FIG. 1, generally, each dynamic template stored in template data 161 includes code that enables the above-described functionality for a dynamic email. Thus, in some embodiments, each dynamic template stored in template data 161 includes code that references information for one or more items, such as a particular product or service. For example, in some embodiments, such item information is referenced via a web address or uniform resource locator (URL) that specifies a location on a computer network. In addition, each dynamic template includes code that enables an interaction functionality that is associated with such item information. Further, such interaction functionality includes an ability to receive a user input. For example, the interaction functionality may include generating an input-receiving area (such as a user-input button, mouse-over area, hotspot, and the like) when a dynamic email is displayed. In the embodiments, the input-receiving area corresponds to a display area in which at least some of the item information is displayed, such as an image (e.g., image 221 in FIG. 2) associated with a particular item or product. Alternatively or additionally, the interaction functionality may include generating an input-receiving area that corresponds to a shopping function associated with the item information or with a particular item. In such embodiments, the shopping function may be an option selection button (such as a size selection, a color selection, etc.) for the particular item (e.g., available size buttons 231 in FIG. 2). In another example, in such embodiments, the shopping function may be a purchase initiation button for a particular item (e.g., click-to-purchase button 235 in FIG. 2). In another example, in such embodiments, the shopping function may be an add-to-cart process for a particular item (e.g., add-to-cart button 234 in FIG. 2).

In some embodiments, product data 162 includes item information associated with items referenced in a dynamic template stored in template data 161. For a particular item referenced in a dynamic template, such item information can include one or more of textual information (e.g., a written description), image information, video and/or audio information, pricing information, and/or option information (such as what sizes, colors, other selectable options, and/or the like are available for the particular item referenced. Alternatively or additionally, in some embodiments, for a particular item referenced in a dynamic template, such information can include one or more links or URLs that reference a source or sources for the above described item information. For example, in some embodiments, such links or URLs are each directed to a particular webpage or object associated with a merchant product feed. Thus, in such embodiments, static item information is not actually stored in product data 162.

In some embodiments, placeholder product data 163 includes information that enables a dynamic template to reference dynamic item information. In such embodiments, placeholder product data 163 may be stored for a particular dynamic template instead of or in addition to static item information, such as that included in product data 162. In a particular dynamic template, references to dynamic item information serve as “placeholder” product information that is replaced with actual item information when a specific email is to be generated from the particular dynamic template. In such embodiments, template generator 151 is configured to replace the placeholder product information with “live” or actual item information, for example based on a user input by a merchant (not shown in FIG. 1) associated with that particular dynamic template. For example, in some embodiments, the merchant can generate a customer-specific email for a particular customer using the particular dynamic template based on abandoned cart information for that particular customer. In such embodiments, the merchant provides the abandoned cart information (e.g., specific item information, in some cases including selected option information) to template generator 151. Template generator 151 replaces placeholder product information 163 in the requested dynamic template with the user-specific item information received from the merchant, so that a user-specific email can be generated using the dynamic template.

FIG. 3 is a flowchart illustrating the steps performed by template generation system 100 as part of a template generation process 300, according to various embodiments. Template generation process 300 may include one or more operations, functions, or actions as illustrated by one or more of blocks 310-380. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with template generation system 100 of FIGS. 1 and 2, persons skilled in the art will understand that within the scope of the present disclosure any suitably configured system can perform template generation process 300.

In block 310, template generator 151 receives a static template. Based on the static template, template generator 151 generates one or more dynamic templates as described below. In some embodiments, each dynamic template can be employed to generate one or a plurality of dynamic, shoppable emails that include item information and interaction functionality that is associated with the item information. In some embodiments, template generator 151 receives the static template from a merchant, an email marketer, and/or the like.

In some embodiments, the static template is a file written in a structured markup language for encoding documents in a format that is both human-readable and machine-readable, such as HTML, CSS, or XML. In addition, the static template is configured to so that one or a plurality of static emails or other electronic messages can be generated based thereon. Static emails do not allow interactions with a recipient of the email beyond receipt of inputs that activate a link included in the static email, such as a URL.

In block 320, template generator 151 identifies one or more shoppable areas indicated in the static template, such as display areas indicated in the code of the static template to display item information. In particular, template generator 151 searches the code of the static template and identifies one or more shoppable areas indicated in the static template based on one or more criteria. In some embodiments, template generator 151 identifies a shoppable area based on a portion of code included in the static template that is associated with causing item information to be displayed when the portion of code interpreted by a client application. Thus, in such embodiments, when the portion of code is included in a static email that is generated based on the static template, and the portion of code is associated with causing item information to be displayed, the area in which the item information is indicated to be displayed can be identified as a shoppable area. In some embodiments, the area in which the item information is indicated to be displayed is identified as a shoppable area when greater than a minimum threshold size and is not identified as a shoppable area when less than the minimum threshold size. In some embodiments, a shoppable area is identified based on image-related information included in the code of the static template, such as a URL that is associated with an image or video. In such embodiments, a display area that is indicated in the code of the static template to be associated with such image-related information is identified as a shoppable area. Alternatively or additionally, in some embodiments, a shoppable area can be identified based on any reference to an image or video included in the code of the static template. Alternatively or additionally, in some embodiments, a shoppable area can be identified based on any reference to an item included in the code of the static template, such as a product link or other URL. Alternatively or additionally, in some embodiments, template generator 151 employs other criteria to identify shoppable areas associated with the static template.

In block 330, template generator 151 converts the static template to a dynamic template format. In some embodiments, template generator 151 adds suitable code to the static template to perform block 330. The suitable code varies depending on the language of the static template and on the dynamic format of the dynamic template. For example, in some embodiments, template generator 151 adds CSS code at the top of the static template file and an AMP-specific header when converting an HTML static template to an AMP-based dynamic template. Additionally or alternatively, in some embodiments, template generator 151 changes the structure of the static template, removes portions of code from the static template, and/or otherwise modifies the code of the static template as appropriate to generate a dynamic template that is based on the static template.

In block 340, template generator 151 determines the interaction functions to be included in the dynamic template. Thus, in block 340, template generator 151 determines, for example, the number and type of user interface elements 230 (e.g., option buttons, check-out buttons, etc.) and/or the number of total shoppable items to be included in the dynamic template. In some embodiments, template generator 151 makes such a determination based on various criteria, such as the dynamic format of the dynamic template, an email display-size limit, the number of shoppable areas identified in the static template in block 320, and/or the like. For example, to avoid exceeding an email display-size limit, in some embodiments, template generator 151 includes a single buy-now button in the dynamic template instead of a buy-now button for each item referenced in the dynamic template, since each buy-now button can result in more additions to the code of the static template for certain dynamic formats. Similarly, to avoid exceeding an email display-size limit, in some embodiments, template generator 151 truncates a number of shoppable areas identified in block 320.

In block 350, template generator 151 adds information display code to the dynamic template generated in block 330. The information display code, when interpreted by an email client application or other application, modifies how item information associated with one or more items is displayed. In some embodiments, the information display code added in block 350 resizes and/or relocates the display of an image of an item that is referenced in the static template. For example, in such embodiments, the resizing and/or relocation of the display of the image may be performed to accommodate user interface elements 230 associated with the item that is referenced in the static template (such as available size buttons 231, menu 232 of available colors, gender selection buttons 233, and/or the like). Alternatively or additionally, in some embodiments, the information display code added in block 350 replaces an image (or reference to an image) associated with an item that is referenced in the static template. In such embodiments, the replacing image may have different displayed dimensions than those of the replaced image. In some embodiments, in block 350 template generator 151 also removes a portion of code included in the dynamic template.

In block 360, template generator 151 adds interaction functionality code to the dynamic template generated in block 330. In some embodiments, the interaction functionality code, when interpreted by an email client application or other application, modifies the dynamic template to include the one or more interaction functions and associated user interface elements 230 that were determined in block 340 to be included in the dynamic template. Thus, in such embodiments, template generator 151 adds code to the dynamic template that enables the determined interaction functionality of the dynamic template (e.g., user interface elements 230 associated with one or more items referenced in the static template). Examples of such added code include data fields, data parameters, CSS, changes to one or more classes, and the like.

In some embodiments, template generator 151 adds code to the dynamic template that enables other functionalities besides interaction functionalities. For example, in some embodiments, template generator 151 adds code that collects additional item information besides the item information already referenced in the dynamic template. In such embodiments, the additional item information may include item information for a “sibling item” that is similar to an item associated with item information already referenced in the dynamic template. In some embodiments, a sibling item is an item that shares one or more attributes (e.g., size, color, style, manufacturer, etc.) with an item that is already referenced in the dynamic template. In another example, in some embodiments, template generator 151 adds code that determines whether item information already referenced in the dynamic template is obsolete. In such embodiments, the code enables a call out, for example to email client interface 152 or a merchant product feed, to determine whether, at time of opening a dynamic email, an item referenced in the dynamic template has been purchased by the recipient of the dynamic email. Such code may further enable the collection of additional item information related to an already purchased item, such as item information for a sibling item. Thus, in such embodiments, for a dynamic email generated based on the dynamic template, at time of opening, code included in the dynamic email can leverage information available at time of opening to facilitate sales of items related or similar to items known to be purchased by a particular email recipient.

In some embodiments, certain code of the dynamic template is also removed in block 360, such as code that was originally included in the static template received in step 310 and is incompatible with the dynamic format of the dynamic template.

In block 370, template generator 151 registers product information, such as item information associated with a particular item that is referenced in the dynamic template. For example, in some embodiments, the item information referenced in the dynamic template is stored in product information 162. In such embodiments, static item information that is associated with the particular item referenced in the dynamic template is stored. In such embodiments, the static item information may include, for example, pricing and/or size or color availability information. Generally the static item information is based on item information that is available when template generation process 300 is taking place, and may be out-of-date at time of open. Alternatively or additionally, in some embodiments, updatable product information is stored in block 370. For example, in such embodiments, the dynamic item information includes a URL or other link associated with a merchant product feed that includes the particular item referenced in the dynamic template. Thus, in such embodiments, when a dynamic email is generated based on the dynamic template, information displayed to a recipient of the email includes item information that is updated at the time of opening the dynamic email.

In block 380, template generator 151 returns the dynamic template for subsequent use. For example, in some embodiments, template generator 151 returns the dynamic template to the merchant, email marketer, or an email service provider. The dynamic email template can then be employed to generate dynamic emails.

In some embodiments, template generation process 300 is employed to generate a single dynamic template from the static template received in block 310. However, in practice, different client applications are configured to support different formats of dynamic emails. As a result, emails generated using a single dynamic template will not be compatible with many client applications. In light of the above, in some embodiments, template generator 151 generates multiple dynamic templates via template generation process 300, each having a different dynamic format (e.g., dynamic HTML, AMP, and the like). In such embodiments, blocks 330-380 are repeated to generate a different format of a dynamic template, where each version is supported by a different email client application.

### Generation of Dynamic Template with Shoppable Areas Based on Merchant Input

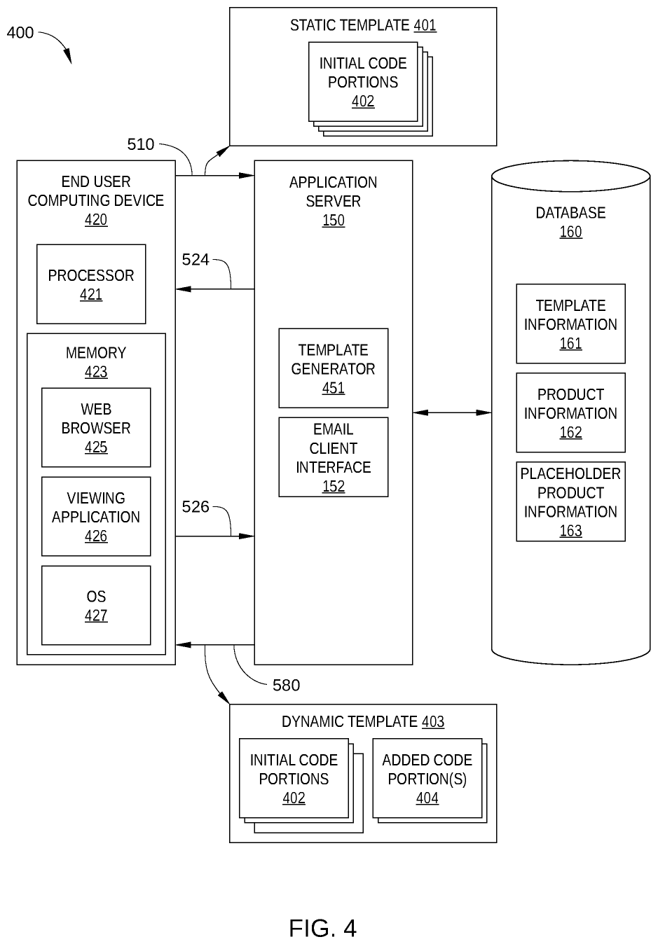

In some embodiments, a dynamic template is generated based in part on merchant input. In such embodiments, potential shoppable areas are automatically identified and presented to a merchant or other end user, and input from the merchant or end user indicates which potential shoppable areas are implemented as actual shoppable areas in the dynamic template. One such embodiment is described below in conjunction with FIGS. 4 and 5.

FIG. 4 is a block diagram of a template generation system 400, according to one or more embodiments. In some embodiments, template generation system 400 is substantially similar in configuration and operation to template generation system 100 of FIG. 1, except for the addition of an end user computing device 420 and a template generator 451 that is configured to interact with end user computing device 420. For reference, also shown in FIG. 4 are various operations of a template generation process that is described below in conjunction with FIG. 5.

End user computing device 420 can be any technically feasible and network-connected computing device. For example, end user computing device 420 can be a desktop computer, laptop computer, smartphone, personal digital assistant (PDA), tablet computer, or any other type of computing device that is configured to receive input, process data, and display images, and is suitable for practicing one or more embodiments of the present invention. Thus, end user computing device 420 is configured to execute a web browser 425, a viewing application 426, an operating system (OS) 427, and/or other software applications. In addition, end user computing device 420 is configured to communicate with application server 150, for example via web browser 426 or other application.

In some embodiments, end user computing device 420 includes a processor 421 and a memory 423. Processor 421 may be any suitable processing unit implemented as a central processing unit (CPU), an application-specific integrated circuit (ASIC), a field programmable gate array (FPGA), any other type of processing unit, or a combination of different processing units. Memory 423 can include any suitable volatile and/or nonvolatile memory (e.g., random-access memory (RAM), read-only memory (ROM), flash memory, a magnetic hard drive, etc.), and is configured to store instructions, data, web browser 425, viewing application 426, operating system (OS) 427, and/or other software applications, etc.

Viewing application 426 is a computer program designed to run and/or view dynamic templates generated by template generator 451. OS 427 supports the functions of processor 421, including scheduling tasks and sending commands to web browser 425, viewing application 426, and memory 423, managing the power state of end user computing device 420, initiating execution of applications on processor 421, managing sockets and TCP connections, and the like. For example, in some embodiments, OS 427 is configured to facilitate the execution of web browser 425, viewing application 426, and/or other software applications.

In operation, template generator 451 generates one or more shoppable email templates based on a particular static email template via a template generation process. In some embodiments, template generator 451 generates the one or more shoppable email templates based on item information referenced or included in the particular static email template and on inputs received from an end user. Examples of such end-user inputs include selections of shoppable areas and end-user provided item information, among others. In such embodiments, an automated template generation process allows a particular end user, such as a merchant associated with the original static template, to provide feedback to and/or confirm the quality and functionality of output from the automated template generation process described herein. One embodiment of such a template generation process is described below in conjunction with FIG. 5.

FIG. 5 is a flowchart illustrating the steps performed by template generation system 400 as part of a template generation process 500, according to various embodiments. Template generation process 500 may include one or more operations, functions, or actions as illustrated by one or more of blocks 510-580. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with template generation system 400 of FIG. 4, persons skilled in the art will understand that within the scope of the present disclosure any suitably configured system can perform template generation process 500.

In block 510, template generator 451 receives a static template 401 from end user computing device 420. As shown, static template 401 includes a plurality of initial code portions 402, such as text-based markup language code. In some embodiments, end user computing device 420 is associated with a merchant, an email marketer, some other end user, and/or the like. Based on static template 401, template generator 451 generates one or more dynamic templates 403 as described below. In some embodiments, each dynamic template 403 can be employed to generate one or a plurality of dynamic, shoppable emails (not shown) that include item information and interaction functionality associated with the item information. In some embodiments, static template 401 received in block 510 is substantially similar in configuration to the static template file described above in conjunction with template generation process 300 of FIG. 3.

In block 520, template generator 451 identifies one or more shoppable areas indicated in static template 401, such as display areas indicated in the code of static template 401 to display item information. In some embodiments, block 520 is substantially similar to block 320 in template generation process 300.

In block 522, template generator 451 adds information display code to static template 401. The information display code, when interpreted by an email client application, web browser, or other application, modifies how item information associated with one or more items is displayed. In some embodiments, the information display code added in block 350 causes the one or more shoppable areas identified in step 520 to be displayed differently when the information display code is interpreted by an email client application, a web browser, such as web browser 425, and/or viewing application 426. Thus, in some embodiments, the information display code added in block 350, when interpreted by an email client application, web browser, or other application, changes a visual prominence and/or appearance of a display area associated with an item that is referenced in static template 401. For example, in such an embodiment, the added information display code includes an image overlay indicating that the display area (or a portion of the display area) associated with the item is a shoppable area. In this way, shoppable areas are indicated to an end user for editing and/or confirmation prior to the conversion of static template 401 to dynamic template 403 by template generator 451.

Alternatively or additionally, in some embodiments, the added information display code, when interpreted by an email client application, web browser, or other application, enables receipt of one or more configuration inputs that indicate a configuration of a shoppable area of the shoppable electronic message. For example, in such embodiments, the added information display code enables one or more user interface elements 230 to receive inputs.

Alternatively or additionally, in some embodiments, the added information display code includes a CSS, one or more tags, and/or other parameters that cause the display area to be highlighted and/or otherwise indicated to be a shoppable area. Such highlighting can include one or more changes in color, one or more additions of a border or other visual indicators, one or more visual effects (e.g., periodic image flashing or color changes), and/or the like. In this way, shoppable areas are indicated to an end user for editing and/or confirmation. In some embodiments, in block 522, template generator 451 also removes one or more initial code portions 402 of code included in static template 401, such as code that is superseded by the information display code added in step 522. Thus, as shown in FIG. 4, in some embodiments, dynamic template 403 includes fewer initial code portions 402 than static template 401.

In some embodiments, the information display code added to static template 401 in block 522 supports or otherwise enables one or more template-editing functions that can be employed by an end user viewing static template 401 after block 522. In some embodiments, such template-editing functions are activated or otherwise enabled via a particular user interface element 230, such as an “Edit Template” button or the like. In such embodiments, the information display code added to static template 401 is configured to send changes made via the one or more template-editing functions to template generator 451. Thus, in such embodiments, shoppable areas identified automatically by template generator 451 can be confirmed and/or modified by an end user. In such embodiments, the one or more template-editing functions may include enablement for an end user to provide additional associations for additional item information (e.g., a product image) to multiple URLs. In such embodiments, the multiple URLs may represent or are associated with a product variant or sibling product. In such embodiments, each of the multiple URLs added may be represented in a drop-down menu, a carousel, or some other visual selection format provided by the information display code added to static template 401. Alternatively or additionally, in such embodiments, the one or more template-editing functions may include enablement of an end user to change a location of a hotspot on a particular image. Alternatively or additionally, in such embodiments, the one or more template-editing functions may include enablement of an end user to add or remove shoppable areas of static template 401, such as a display area associated with an image referenced in the static template.

In some embodiments, the information display code added to static template 401 in block 522 supports or otherwise enables a user interface that provides user prompts and other functionality for facilitating end-user selections by an end user subsequently viewing static template 401. In some embodiments, the information display code added to static template 401 is configured to respond to certain user inputs, such as a user input action (e.g., a mouse click) to select a shoppable area of static template 401. In such embodiments, the information display code added to static template 401 is configured to cause a pop-up window, a drop-down menu, or some other modal display or user interface element to be displayed that can receive further input from the end-user. In such embodiments, the user interface element enables collection of additional information from the end-user related to a particular shoppable area, such as which interaction functionalities and associated user interface elements 230 are to be associated with the particular shoppable area. Further, in such embodiments, the information display code for generating the user interface is configured to send changes made via one or more of user interface elements 230 to template generator 451. Thus, in such embodiments, interaction functionalities and/or user interface elements 230 that are associated with a particular shoppable area can be modified or otherwise fine-tuned by the end user.

In block 524, template generator 451 returns a modified static template 401 to the end user.

In block 526, template generator 451 receives one or more inputs from modified static template 401 that is transmitted to the end user in block 524. The one or more inputs are generated when the end user opens or otherwise views the modified static template 401, for example via web browser 425 or viewing application 426, and makes one or more selections. In some embodiments, the one or more inputs are generated via functionality enabled by the information display code added to the static template in block 522, such as one or more template-editing functions and/or user interface elements.

In block 530, template generator 451 converts static template 401 to a dynamic template format. In some embodiments, block 530 is substantially similar to block 330 in template generation process 300.

In block 540, template generator 451 determines the interaction functions to be included in a dynamic template 403. Thus, in block 540, template generator 451 determines, for example, the number and type of option buttons, the number of check-out buttons, and/or the number of total shoppable items to be included in dynamic template 403. In some embodiments, block 540 is substantially similar to block 340 in template generation process 300.

In block 550, template generator 451 adds information display code to dynamic template 403 generated in block 530. The information display code, when interpreted by an email client application or other application, modifies how item information associated with one or more items is displayed. In some embodiments, block 550 is substantially similar to block 350 in template generation process 300. Further, in some embodiments, information display code added to static template 401 in block 522 is removed, such as code causing the one or more shoppable areas identified in step 520 to be displayed differently, code enabling one or more template-editing functions, and/or code enabling a user interface that provides user prompts and other functionality for facilitating end-user selections.

In block 560, template generator 451 adds interaction functionality code to dynamic template 403 generated in block 530, for example as added code portions 404. In some embodiments, the interaction functionality code, when interpreted by an email client application or other application, modifies dynamic template 403 to include the one or more interaction functions and associated user interface elements 230 that were determined in block 540 to be included in the dynamic template. In some embodiments, block 560 is substantially similar to block 360 in template generation process 300.

In block 570, template generator 451 registers product information, such as item information associated with a particular item that is referenced in dynamic template 403. In some embodiments, block 570 is substantially similar to block 370 in template generation process 300.

In block 580, template generator 451 returns dynamic template 403 for subsequent use. For example, in some embodiments, template generator 451 returns dynamic template 403 to the merchant, email marketer, or an email service provider. Dynamic template 403 can then be employed to generate dynamic emails.

Similar to template generation process 300, in some embodiments, template generation process 500 can be employed to generate a single dynamic template 403 or multiple dynamic templates 403 from static template 401 received in block 510. In the latter case, template generator 451 generates multiple dynamic templates 403 via template generation process 500, each having a different dynamic format (e.g., dynamic HTML, AMP, and the like). In such embodiments, blocks 530-580 are repeated to generate a different format of a dynamic template, where each version is supported by a different client application.

### Use of Dynamic Shoppable Email

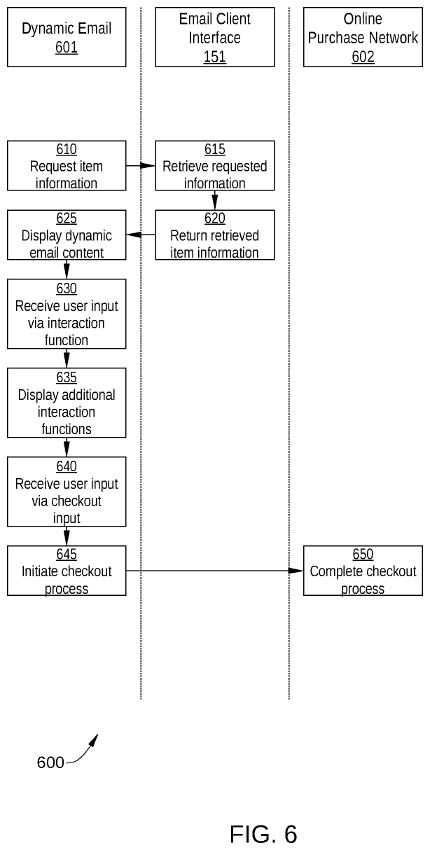

In some embodiments, a shoppable electronic message (e.g., a dynamic shoppable email) is based on an automatically generated dynamic template, such as the dynamic template generated via template generation process 300 or 500. In such embodiments, the shoppable electronic message can be employed as an interactive electronic message that facilitates email marketing and/or other types of e-commerce. One such embodiment is described below in conjunction with FIG. 6.

FIG. 6 is a flowchart illustrating the steps of an online purchasing process 600, according to various embodiments. Online purchasing process 600 may include one or more operations, functions, or actions as illustrated by one or more of blocks 610-645. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with template generation system 100 of FIG. 1 and template generation system 400 of FIG. 4, persons skilled in the art will understand that within the scope of the present disclosure any suitably configured system can perform online purchasing process 600.

In online purchasing process 600, steps are performed in sequence by email client interface 152, a dynamic email 601, and, in some embodiments, an online purchase network 602. Prior to online purchasing process 600, dynamic email 601 is generated based on a dynamic template, such as dynamic template 403 of FIG. 4. Dynamic email 601 is then opened or otherwise viewed by a recipient, for example via an email client application.

In block 610, in response to dynamic email 601 being opened or viewed, dynamic email 601 makes one or more requests for item information referenced in the code of dynamic email 601. For example, dynamic email 601 requests such item information based on URLs, links, or other references to item information included in the code of dynamic email 601. In some embodiments, dynamic email 601 also requests customer-specific information, such as recent purchasing information for the current recipient of dynamic email 601.

In block 615, email client interface 152 receives the one or more requests from dynamic email 601 and, in response, retrieves the requested item information. In some embodiments, the requested item information is retrieved from product information 162 stored in database 160 and/or from a product feed included in product information 162. In some embodiments, requested customer-specific information is also retrieved, for example from a merchant website referenced in product information 162 and/or template information 161.

In block 620, email client interface 152 returns the retrieved item information to dynamic email 601, such as item images, pricing information, and the like. In some embodiments, the retrieved item information includes static product information stored in product information 161, such as product information stored when dynamic template 403 is generated. Alternatively or additionally, in some embodiments, the retrieved item information includes up-to-date item information, such as item information retrieved via a merchant product feed. Alternatively or additionally, in some embodiments, the retrieved item information includes dynamic item information, such as customer-specific item information based on abandoned cart information associated with the recipient of dynamic email 601.

In block 625, dynamic email 601 receives the returned item information and, in response, displays dynamic email content 210, for example via the email client application or other application that has opened dynamic email 601. As noted previously, dynamic email content 210 can include item information, interaction functions, and/or associated user interface elements 230 that enable purchasing of items referenced by the item information. In some embodiments, the display of one or more of user interface elements 230 depends on the returned item information. For example, in such embodiments, the display of collapsible sections (e.g., drop-down menus), selectable options, and/or transaction buttons can vary based on what item information is available at time of open of dynamic email 601.

In block 630, dynamic email 601 receives a user input via an interaction function or associated user interface element 230. For example, a user viewing dynamic email 601 may click on or otherwise select an expandable user interface element 230, such as a “select color” button, a “select size” button, a “view product” button, and/or the like.

In block 635, dynamic email 601 causes one or more appropriate additional user interface elements 230 to be displayed, such as a drop-down menu, carousel, or other group of buttons for selecting from available colors, sizes etc. In some embodiments, the user interface elements 230 displayed in block 635 are based on item information received by dynamic email 601 in block 625. Subsequently, dynamic email 601 may receive one or more user inputs via the additional user interface elements 230 displayed in block 635. Inputs received by the additional user interface elements 230 and/or other user interface elements 230 (e.g., user selections) are stored or logged in the code for dynamic email 601. In some embodiments, such inputs are stored by saving the state of such inputs locally in variables via element states. Additionally or alternatively, in some embodiments, such information can be passed on to application server 150 and/or database 160.

In block 640, dynamic email 601 receives a user input via a checkout input received via a user interface element 230, such as a “Click-to-Purchase” button, a “Checkout Now” button, and/or the like.

In block 645, dynamic email 601 initiates a checkout/purchase process. In some embodiments, the checkout/purchase process is based on the user selections tracked by dynamic email 601. In some embodiments, shipping and/or billing information is collected in such a process.

Alternatively, in other embodiments, in block 650, initiation and completion of the checkout/purchase process is completed via a process that involves a single user input action, such as the user input received in block 640. In such a process, online purchase network 602 enables the online purchase to be initiated and completed via the single input action by a user. One such process is described in detail in U.S. patent application Ser. No. 16/944,125, entitled “Initiation and Completion of an Online Transaction Via a Single User Input Action” and filed on Jul. 30, 2020, the contents of which are incorporated herein in their entirety.

FIG. 7 is an illustration of a computing device 700 configured to perform various embodiments of the present disclosure. Computing device 700 may be a desktop computer, a laptop computer, a smart phone, or any other type of computing device suitable for practicing one or more embodiments of the present disclosure. In operation, computing device 700 is configured to execute instructions associated with template generator 151, email client interface 152, template generator 451, template generation process 300, and/or template generation process 500 as described herein. It is noted that the computing device described herein is illustrative and that any other technically feasible configurations fall within the scope of the present disclosure.

As shown, computing device 700 includes, without limitation, an interconnect (bus) 740 that connects a processing unit 750, an input/output (I/O) device interface 760 coupled to input/output (I/O) devices 780, memory 710, a storage 730, and a network interface 770. Processing unit 750 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU or digital signal processor (DSP). In general, processing unit 750 may be any technically feasible hardware unit capable of processing data and/or executing software applications, including template generator 151, email client interface 152, template generator 451, template generation process 300, and/or template generation process 500.

I/O devices 780 may include devices capable of providing input, such as a keyboard, a mouse, a touch-sensitive screen, and so forth, as well as devices capable of providing output, such as a display device and the like. Additionally, I/O devices 780 may include devices capable of both receiving input and providing output, such as a touchscreen, a universal serial bus (USB) port, and so forth. I/O devices 780 may be configured to receive various types of input from an end-user of computing device 700, and to also provide various types of output to the end-user of computing device 700, such as displayed digital images or digital videos. In some embodiments, one or more of I/O devices 780 are configured to couple computing device 700 to a network.

Memory 710 may include a random access memory (RAM) module, a flash memory unit, or any other type of memory unit or combination thereof. Processing unit 750, I/O device interface 760, and network interface 770 are configured to read data from and write data to memory 710. Memory 710 includes various software programs that can be executed by processor 750 and application data associated with said software programs, including template generator 151, email client interface 152, template generator 451, template generation process 300, and/or template generation process 500.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A computer-implemented method for generating a template for a shoppable electronic message, the method comprising:
receiving at a processor a static template that references item information;
with the processor, identifying a first portion of code included in the static template that is associated with causing the item information to be displayed when the first portion of code is interpreted by a client application; and
with the processor, generating a dynamic template by adding a second portion of code to the static template,
wherein the second portion of code, when interpreted by the client application, enables an interaction functionality of the shoppable electronic message that is associated with the item information and includes an ability to receive a user input.

2. The computer-implemented method of claim 1, wherein the static template includes a structured markup language.

3. The computer-implemented method of claim 1, wherein generating the dynamic template comprises converting, with the processor, the static template to a dynamic template format by adding a third portion of code to the dynamic template.

4. The computer-implemented method of claim 3, wherein the third portion of code comprises header information associated with the dynamic template format.

5. The computer-implemented method of claim 1, wherein the interaction functionality includes at least one of an option selection function or a transaction function.

6. The computer-implemented method of claim 1, further comprising:
determining a product or service that is associated with the item information; and
adding a third portion of code to the dynamic template, wherein the third portion of code, when interpreted by the client application, causes updated item information of the product or the service to be displayed in the shoppable electronic message.

7. The computer-implemented method of claim 6, wherein the updated item information includes at least one of additional item information that is associated with the product or service or information associated with the product or service that is more recently updated than the item information referenced in the static template.

8. The computer-implemented method of claim 6, wherein the third portion of code, when interpreted by the client application, causes the updated item information to be retrieved from a computing device that is not running the client application.

9. The computer-implemented method of claim 6, wherein the second portion of code enables the interaction functionality with a configuration that is based on the updated item information.

10. The computer-implemented method of claim 1, further comprising, adding a third portion of code to the dynamic template, wherein the third portion of code, when interpreted by the client application:
modifies how the item information is displayed in the electronic message; and
enables receipt of one or more configuration inputs that indicate a configuration of a shoppable area of the shoppable electronic message, wherein the shoppable area is associated with the item information.

11. The computer-implemented method of claim 10, wherein the third portion of code, when interpreted by the client application, modifies how the item information is displayed by changing a visual prominence of a display area associated with the item information.

12. The computer-implemented method of claim 10, wherein the third portion of code, when interpreted by the client application, enables receipt of the one or more configuration inputs via a user interface element associated with the item information.

13. The computer-implemented method of claim 1, further comprising, adding a third portion of code to the dynamic template, wherein the third portion of code is configured to enable a user interface for receiving an input that is associated with at least one of selecting a shoppable area of the shoppable electronic message and modifying an interaction functionality associated with the shoppable area.

14. The computer-implemented method of claim 1, further comprising, adding a third portion of code to the dynamic template, wherein the third portion of code is configured to enable one or more template-editing functions for modifying an appearance one or more shoppable areas of the shoppable electronic message when the shoppable electronic message is interpreted by the client application.

15. The computer-implemented method of claim 14, wherein the third portion of code is further configured to enable sending changes made via the one or more template-editing functions to the processor.

16. The computer-implemented method of claim 14, wherein the one or more template-editing functions include providing a reference to additional item information in the dynamic template.

17. The computer-implemented method of claim 1, further comprising determining, with the processor, a number of interaction functions to be included in the dynamic template

18. The computer-implemented method of claim 17, wherein the number of interaction functions to be included in the dynamic template is based on at least one of a dynamic format of the dynamic template, an email display-size limit of the dynamic format, or a number of shoppable areas identified in the static template.

19. The computer-implemented method of claim 1, wherein the dynamic template is configured for the generation of the shoppable electronic message.

20. A non-transitory computer readable medium that includes a set of instructions which, in response to execution by a processor of a computer system, cause the process to perform a method of generating a template for a shoppable electronic message, the method comprising:
receiving at a processor a static template that references item information;
with the processor, identifying a first portion of code included in the static template that is associated with causing the item information to be displayed when the first portion of code is interpreted by a client application; and
with the processor, generating a dynamic template by adding a second portion of code to the static template,
wherein the second portion of code, when interpreted by the client application, enables an interaction functionality of the shoppable electronic message that is associated with the item information and includes an ability to receive a user input

21. A first computing device for generating a template for a shoppable electronic message, the first computing device comprising:
a first processor; and
a memory storing instructions that, in response to execution by the first processor, cause the first processor to perform:
receiving a static template from a second computing device, wherein the second template references item information;
identifying a first portion of code included in the static template that is associated with causing the item information to be displayed when the first portion of code is interpreted by a client application running on the first computing device; and
generating a dynamic template by adding a second portion of code to the static template,
wherein the second portion of code, when interpreted by the client application, enables an interaction functionality of the shoppable electronic message that is associated with the item information and includes an ability to receive a user input.
